(19) United States
(12) Patent Application Publication
(10) Pub. No.: US 2007/0141312 A1
(43) Pub. Date: Jun. 21, 2007

(54) Multilayered polishing pads having improved defectivity and methods of manufacture

(76) Inventor: David B. James, Newark, DE (US)

Correspondence Address: ROHM AND HAAS ELECTRONIC MATERIALS;CMP HOLDINGS, INC., 451 BELLEVUE ROAD, NEWARK, DE, 19713, US

(21) Appl. No.: 11/316,029

(22) Filed: Dec. 21, 2005

(51) Int. Cl. B32B 7/02

(52) U.S. Cl. 428/212

(57) ABSTRACT

The present invention provides a composite chemical mechanical polishing pad for polishing a semiconductor substrate comprising, a polishing layer having a first compressibility, an intermediate layer having a second compressibility less than the first compressibility and a bottom layer having a third compressibility greater than the second compressibility and less than the first compressibility. The polishing layer has at least a fifty volume percent level of porosity. The present invention provides multi-layered, water-based polishing pad with reduced defectivity and improved polishing performance.

### BACKGROUND OF THE INVENTION

The present invention relates to polishing pads for chemical mechanical planarization (CMP), and in particular, relates to multi-layered polishing pads and methods of manufacturing multi-layered polishing pads that enable low defectivity polishing.

In the fabrication of integrated circuits and other electronic devices, multiple layers of conducting, semiconducting and dielectric materials are deposited on or removed from a surface of a semiconductor wafer. Thin layers of conducting, semiconducting, and dielectric materials may be deposited by a number of deposition techniques. Common deposition techniques in modern processing include physical vapor deposition (PVD), also known as sputtering, chemical vapor deposition (CVD), plasma-enhanced chemical vapor deposition (PECVD), and electrochemical plating (ECP).

As layers of materials are sequentially deposited and removed, the uppermost surface of the wafer becomes non-planar. Because subsequent semiconductor processing (e.g., metallization) requires the wafer to have a flat surface, the wafer needs to be planarized. Planarization is useful in removing undesired surface topography and surface defects, such as rough surfaces, agglomerated materials, crystal lattice damage, scratches, and contaminated layers or materials.

Chemical mechanical planarization, or chemical mechanical polishing (CMP), is a common technique used to planarize substrates, such as semiconductor wafers. In conventional CMP, a wafer carrier is mounted on a carrier assembly and positioned in contact with a polishing pad in a CMP apparatus. The carrier assembly provides a controllable pressure to the wafer, pressing it against the polishing pad. The pad is moved (e.g., rotated) relative to the wafer by an external driving force. Simultaneously therewith, a chemical composition (“slurry”) or other fluid medium is flowed onto the polishing pad and into the gap between the wafer and the polishing pad. Thus, the wafer surface is polished and made planar by the chemical and mechanical action of the slurry and pad surface.

Casting polymers (e.g., polyurethane) into cakes and cutting (“skiving”) the cakes into several thin polishing pads has proven to be an effective method for manufacturing “hard” polishing pads with consistently reproducible polishing properties. Unfortunately, polyurethane pads produced from the casting and skiving method can have polishing variations arising from a polishing pad's casting location. For example, pads cut from a bottom casting location and a top casting can have different densities and porosities. Furthermore, polishing pads cut from molds of excessive size can have center-to-edge variations in density and porosity within a pad. These variations can adversely affect polishing for the most demanding applications, such as patterned wafers incorporating brittle, porous low k dielectrics.

Also, coagulating polymers utilizing a solvent/non-solvent process to form polishing pads in a web format has proven to be an effective method of manufacturing “soft” polishing pads. This method (i.e., web-format) obviates some of the drawbacks discussed above that are found in the casting and skiving process. Unfortunately, the (organic) solvent that is typically used (e.g., N,N-dimethyl formamide) may be cumbersome and cost prohibitive to handle. In addition, these soft pads may suffer from pad-to-pad variations due to the random placement and structure of the porosities that are formed during the coagulation process.

In addition, polishing pads may be formed by combining two or more pads together. For example, Pierce et al., in U.S. Pat. No. 5,287,663, discloses polishing pads for performing CMP that are formed by laminating three layers of different materials. The upper, relatively incompressible polishing layer is attached to a rigid layer formed from a material suitable for providing rigidity to the incompressible polishing layer. The rigid layer is provided over a resilient layer made of a compressible material for providing resilient pressure to the rigid layer. The three-layered polishing pad of Pierce is designed to operate in an “elastic flexure mode”. In other words, the rigid layer and the resilient layer work in tandem to induce a controlled flex in the polishing surface so that it conforms to the global topography of the surface of the wafer while maintaining a controlled rigidity over the local topography of the wafer surface.

Unfortunately, the composite polishing pad of Pierce is inadequate to meet future, more stringent, defectivity requirements. For example, the hard and relatively, incompressible polishing layer of Pierce creates unacceptable levels of defectivity in the polished surface, in particular, for Cu-Low K materials. Although, a hard pad is desired to achieve the required polishing rates, especially in view of the very low down forces (e.g., less than 1 psi) that will be utilized in low K polishing.

Thus, there is a demand for a polishing pad that provides consistent polishing performance, lower defectivity, and is cost effective to manufacture. In addition, what is needed is a polishing pad with improved density and porosity uniformity.

### STATEMENT OF THE INVENTION

In an aspect of the present invention, there is provided a composite chemical mechanical polishing pad for polishing a semiconductor substrate comprising, a polishing layer having a first compressibility; an intermediate layer having a second compressibility less than the first compressibility; a bottom layer having a third compressibility greater than the second compressibility and less than the first compressibility; and wherein the polishing layer has at least a fifty volume percent level of porosity.

### BRIEF DESCRIPTION OF THE DRAWINGS

FIG. 1 illustrates an apparatus for continuous manufacturing of the multi-layered polishing pad of the present invention;

FIG. 1A illustrates another manufacturing apparatus of the present invention;

FIG. 2 illustrates an apparatus for continuous conditioning of the multi-layered polishing pad of the present invention;

FIG. 3 illustrates a cross section of the multi-layered polishing pad manufactured according to the apparatus disclosed by FIG. 1;

FIG. 3A illustrates another multi-layered polishing pad manufactured according to the apparatus disclosed by FIG. 1; and

FIG. 3B illustrates another multi-layered polishing pad manufactured according to the apparatus disclosed by FIG. 1.

### DETAILED DESCRIPTION OF THE INVENTION

The present invention provides a multi-layered polishing pad with reduced defectivity and improved polishing performance. Preferably, the polishing pad is manufactured in a web-format and reduces the pad-to-pad variations often associated with cast and skived “hard” polishing pads. In addition, the polishing pad is preferably water-based rather than organic-solvent based, and easier to manufacture than prior art “soft” pads formed by a coagulation process. Also, the polishing pad is highly porous and multi-layered, providing reduced defectivity without sacrificing other polishing metrics, such as, removal rate, topographical control and pad-life. The polishing pad of the present invention is useful for polishing semiconductor substrates, rigid memory disks, optical products and for use in polishing various aspects of semiconductor processing, for example, ILD, STI, tungsten, copper, low-k dielectrics and ultra low-k dielectrics.

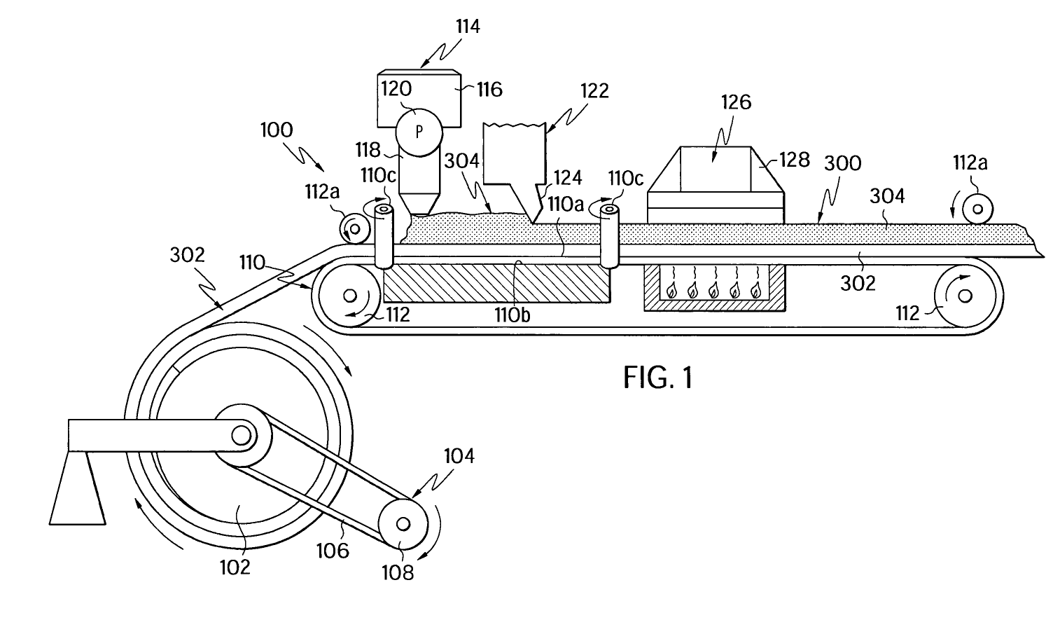

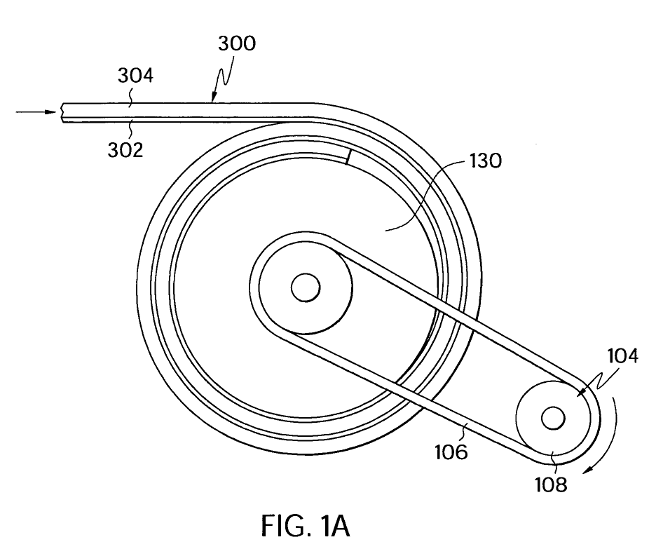

Referring now to the drawings, FIG. 1 discloses an apparatus 100 for manufacturing a multi-layered polishing pad 300 of the present invention. Preferably, the polishing pad 300 has a high level of porosity to hold as much polishing slurry or reactive liquid, in contact with the wafer, as possible. As recognized by the inventor, for future polishing requirements, the chemical contribution of polishing will become more important than the mechanical contribution. Accordingly, the polishing pad 300 of the present invention is a multi-layered, porous (“poromeric”) polishing pad having a polishing layer 304 that has a porosity level of at least 50 volume percent or greater. More preferably, the polishing pad 300 of the present invention is a poromeric polishing pad having a top pad porosity level of at least 65 volume percent or greater. Most preferably, the polishing pad 300 of the present invention is a poromeric polishing pad having a top pad porosity level of at least 75 volume percent or greater. The poromeric, top polishing layer 304, in conjunction with the “dual” subpad (further discussed below) provides the multi-layered, polishing pad of the present invention that provides reduced defectivity without sacrificing other polishing metrics, such as, removal rate, topographical control and pad-life.

Further, the polishing pad 300 of the present invention has a porosity that is interconnected through the thickness of the polishing layer 304. In this way, the polishing debris may be absorbed into the polishing layer 304 and distributed away from the polishing layer (interface) toward the lower surface of the top, polishing layer 304. Also, the top layer, which will be compressible due to its high porosity and saturation in polishing fluid, can act as a pump forcing the fluid against the wafer surface during repetitive cyclic transitions under the wafer. Additionally, the interconnected pore structure of the polishing pad 300 is uniform throughout the thickness of the polishing layer 304 such that, as the pad wears, the pore cross-sectional geometry and surface area in contact with the wafer remains constant. The pore structure may be interconnected micropores or columnar.

The polishing layer 304 of the polishing pad 300 may be formed by various processes including, sintering, stretching, track etching, template leaching and phase inversion. In particular, methods of phase inversion include, for example, precipitation by solvent evaporation, precipitation from vapor phase, precipitation by controlled evaporation, thermal precipitation and immersion precipitation. Other methods of making interconnected pores include, using supercritical fluids or low density foam technology.

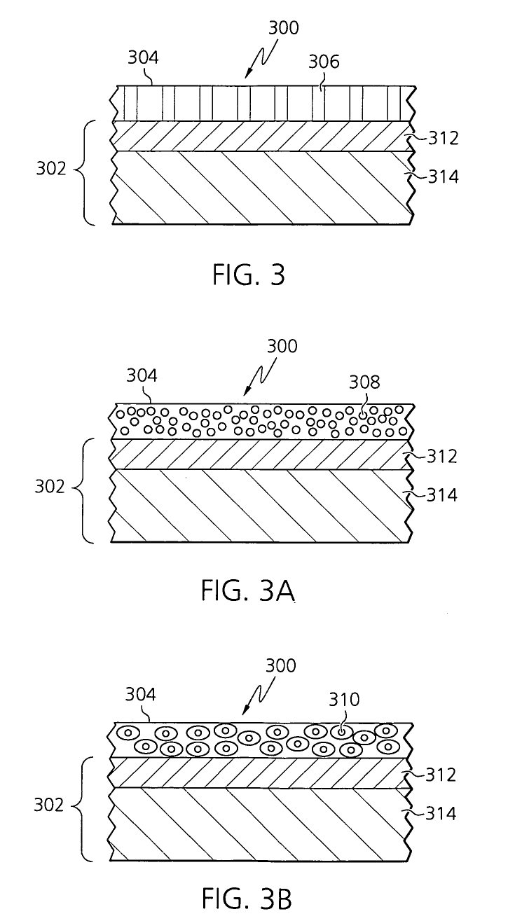

In an embodiment of the present invention, the multi-layered polishing pad 300 is formed in a “rolled” format that allows “continuous manufacturing” to reduce variations among different polishing pads 300 that may be caused by batch processing. The apparatus 100 includes a feed reel or an unwind station 102 that stores a helically-wrapped substrate 302 in lengthwise continuous form. As further discussed below with respect to FIGS. 3 to 3B, substrate 302 comprises a “dual” sub-pad design, including an intermediate, stiff layer 312 and a bottom, compressible layer 314. In this way, the stiff, intermediate layer 312 balances stiffness at die-scale lengths but works in conjunction with the more compressible layer 314 to be flexible at wafer-scale lengths.

The feed roller 102 is mechanically driven to rotate at a controlled speed by a drive mechanism 104. The drive mechanism 104 includes, for example, a belt 106 and motor drive pulley 108. Optionally, the drive mechanism 104 includes, a motor driven flexible shaft or a motor driven gear train (not shown).

Referring still to FIG. 1, the continuous substrate 302 is supplied by the feed reel 102 onto a continuous conveyor 110, for example, a stainless steel belt, that is looped over spaced apart drive rollers 112. The drive rollers 112 may be motor driven at a speed that synchronizes linear travel of the conveyor 110 with that of the continuous substrate 302. The substrate 302 is transported by the conveyor 110 along a space between each drive roller 112 and a corresponding idler roller 112a. The idler roller 112a engages the conveyor 110 for positive tracking control of the substrate 302. The conveyor 110 has a flat section 110a supported on a flat and level surface of a table support 110b, which supports the substrate 302 and transports the substrate 302 through successive manufacturing stations 114, 122 and 126. Support members 110c in the form of rollers are distributed along the lateral edges of the conveyor 110 and the substrate 302 for positive tracking control of the conveyor 110 and the substrate 302.

The first manufacturing station 114 further including a storage tank 116 and a nozzle 118 at an outlet of the tank 116. A viscous, fluid state polymer composition is supplied to the tank 116, and is dispensed by the nozzle 118 onto the continuous substrate 302. The flow rate of the nozzle 118 is controlled by a pump 120 at the outlet of the tank 116. The nozzle 118 may be as wide as the width of the continuous substrate 302 to cover the entirety of substrate 302. As the conveyor 110 transports the substrate 302 past the manufacturing station 114, a continuous-fluid phase polishing layer 304 is supplied onto the substrate 302. The fluid state polymer composition may be adhered to the substrate 302 by conventional adhesive techniques.

Because the raw materials can be mixed in a large homogeneous supply that repeatedly fills the tank 116, variations in composition and properties of the finished product are reduced. In other words, the present invention provides a web-format method of manufacturing a water-based polishing pad to overcome the problems with prior art cast and skive techniques. The continuous nature of the process enables precise control for manufacturing a multi-layered, poromeric polishing pad 300 from, which large numbers of individual polishing pads 300 are cut to a desired area pattern and size. The large numbers of individual polishing pads 300 have reduced variations in composition and properties.

Preferably, the fluid state polymer composition is water-based. For example, the composition may comprise a water-based urethane dispersion (e.g., W-290H, W-293, W-320, W-612 and A-100 from Crompton Corp. of Middlebury, Conn. and HP-1035 and HP-5035 from Cytec Industries Inc. of West Paterson, N.J.) and acrylic dispersion (e.g., Rhoplex® E-358 from Rohm and Haas Co. of Philadelphia, Pa.). In addition, blends, such as, acrylic/styrene dispersions (e.g., Rhoplex® B-959 and E-693 from Rohm and Haas Co. of Philadelphia, Pa.) may be utilized. In addition, blends of the water-based urethane and acrylic dispersions may be utilized.

In a preferred embodiment of the invention, a blend of the water-based urethane and acrylic dispersion is provided at a ratio by weight percent of 100:1 to 1:100. More preferably, a blend of the water-based urethane and acrylic dispersion is provided at a ratio by weight percent of 10:1 to 1:10. Most preferably, a blend of the water-based urethane and acrylic dispersion is provided at a ratio by weight percent of 3:1 to 1:3.

The water-based polymer is effective for forming porous and filled polishing pads. For purposes of this specification, filler for polishing pads include solid particles that dislodge or dissolve during polishing, and liquid-filled particles or spheres. For purposes of this specification, porosity includes gas-filled particles, gas-filled spheres and voids formed from other means, such as mechanically frothing gas into a viscous system, injecting gas into the polyurethane melt, introducing gas in situ using a chemical reaction with gaseous product or decreasing pressure to cause disolved gas to form bubbles. In addition, pores may be formed by destabilizing the aqueous polymer dispersion by, for example, changing the pH, changing the ionic strength or changing the temperature.

Optionally, the fluid state polymer composition may contain other additives, including, a defoamer (e.g., Foamaster® 111 from Cognis) and rheology modifiers (e.g., Acrysol® ASE-60, Acrysol I-62, Acrysol RM-12W, Acrysol RM-825 and Acrysol RM-8W all from Rohm and Haas Company. Other additives, for example, an anti-skinning agent (e.g., Borchi-Nox® C3 and Borchi-Nox M2 from Lanxess Corp.) and a coalescent agent (e.g., Texanol® Ester alcohol from Eastman Chemicals) may be utilized. In addition, the polishing layer should be made of a soft polymer or polymer blend with at least one of the phases having a glass transition temperature below room temperature. Also, addition of additives such as carbon black to improve abrasion resistance, PTFE to reduce friction, or surfactants to improve wettability may be included.

A second manufacturing station 122 includes, for example, a doctor blade 124 located at a predetermined distance from the continuous substrate 302 defining a clearance space therebetween. As the conveyor 110 transports the continuous substrate 302 and the fluid phase polishing layer 304 past the doctor blade 124 of the manufacturing station 122, the doctor blade 124 continuously shapes the fluid phase polishing layer 304 to a predetermined thickness.

A third manufacturing station 126 includes a curing oven 128, for example, a heated tunnel that transports the continuous substrate 302 and the polishing layer 304. The oven 128 cures the fluid phase polishing layer 304 to a continuous, solid phase polishing layer 304 that adheres to the continuous substrate 302. The water should be removed slowly to avoid, for example, surface blisters. The cure time is controlled by temperature and the speed of transport through the oven 128. The oven 128 may be fuel fired or electrically fired, using either radiant heating or forced convection heating, or both.

Preferably, the temperature ofthe oven 128 may be between 50° C. to 150° C. More preferably, the temperature of the oven 128 may be between 55° C. to 130° C. Most preferably, the temperature of the oven 128 may be between 60° C. to 120° C. In addition, the polishing layer 304 may be moved through the oven 128 at a speed of 5 fpm to 20 fpm (1.52 mps to 6.10 mps). Preferably, the polishing layer 304 may be moved through the oven 128 at a speed of 5.5 fpm to 15 fpm (1.68 mps to 4.57 mps). More preferably, the polishing layer 304 may be moved through the oven 128 at a speed of 6 fpm to 12 fpm (1.83 mps to 3.66 mps).

Referring now to FIG. 1A, upon exiting the oven 128, the continuous substrate 302 is adhered to a continuous, solid phase polishing layer 304 to comprise, a continuous, multi-layered, poromeric polishing pad 300. The multi-layered polishing pad 300 is rolled helically onto a take up reel 130, which successively follows the manufacturing station 126. The take up reel 130 is driven by a second drive mechanism 104. The take up reel 130 and second drive mechanism 104 comprise, a separate manufacturing station that is selectively positioned in the manufacturing apparatus 100.

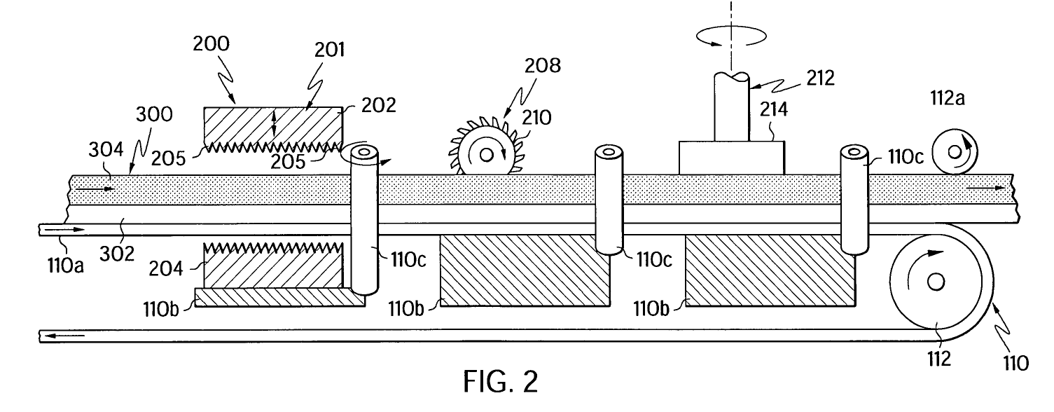

Referring now to FIG. 2, an apparatus 200 for surface conditioning or surface finishing of the continuous, multi-layered polishing pad 300 is optionally provided. The apparatus 200 includes either a similar conveyor 110 as that disclosed by FIG. 1, or a lengthened section of the same conveyor 110. The conveyor 110 of apparatus 200 has a drive roller 112, and a flat section 110a supporting the multi-layered polishing pad 300 that has exited the oven 126. The conveyor 110 of apparatus 200 transports the continuous polishing pad 300 through one or more manufacturing stations 201, 208 and 212, where the polishing pad 300 is further processed subsequent to curing in the oven 126. The apparatus 200 is disclosed with additional flat table supports 110b and additional support members 110c, which operate as disclosed with reference to FIG. 1.

The solidified polishing layer 304 may be diamond buffed, rather than buffed with sandpaper, to expose a desired surface finish and planar surface level of the polishing layer 304. Preferable, the polishing layer 304 may be split to expose a desired surface finish. In this way, the asperity height of the pas surface is controlled over a tight range and this distribution is maintained over the pad lifetime. Hence, defects, especially microscratches and chatter marks, localized point contact pressures between abrasive particles/pad asperities and the wafer surface are minimized. In other words, polishing forces are uniformly distributed over a large number of contact points rather than concentrated over a smaller number. To that end, with respect to polymer blending and the addition of “rubbery” polymers, the inventor has discovered that certain polymers may open up the surface of the polishing layer that would facilitate liquid exchange and provide more uniform pore structure throughout the thickness of the polishing layer (e.g., Paraloid EXL™ 2691).

Although topographical control at the feature level of such parameters as conductor dishing and oxide erosion has a strong slurry dependence, the pad surface asperity distribution is also believed to play a role especially with respect to feature dishing. As discussed, control of the asperity height distribution is important in order to reduce high point pressure spots. In a somewhat analogous manner, if the asperities are of comparable or smaller size than the conductor line widths, the asperities can gouge out features and increase dishing. This can be minimized by ensuring a uniform distribution of asperity heights, with the asperities having effective tip diameters greater than the feature size. The tips should be rounded rather than sharp and the asperities should have a low rather than high aspect ratio. Under polishing pressures and conditions, the asperities should have good resiliency so that deformation during contact with the wafer is reversible. This may reduce the use of diamond conditioning.

During polishing, abrasive particles remove wafer material by combining with the pad asperities to affect a mechanical removal effect. If the forces between the hard abrasive particles and the wafer surface are too high, micro-scratching of the wafer surface may occur. To minimize this, the asperities should have physical properties such that the abrasive particles can partially or completely penetrate into the asperity. This is analogous to glass polishing wherein abrasive particles sink into the surface of pitch. For penetration, the key properties of the asperities are low yield strength and modulus.

Another optional feature of the present invention is the presence of macroscopic grooves in the top layer. These reduce suction between the pad and the wafer such that the wafer releases after polishing and to control fluid transport across the pad surface during polishing. The latter ensures more efficient polishing and can be used to control the polishing profile across the wafer surface and as an additional method to lower defectivity. The grooves may be circular, cross-hatch, spiral or radial designs, or combinations thereof, including, certain modified radial or spiral groove designs optimized for the specific application.

Asperities in the form of grooves or other indentations, are worked into the surface of the polishing layer 304, as desired. For example, a work station 201 includes a pair of compression forming, stamping dies having a reciprocating stamping die 202 and a fixed die 204 that close toward each other during a stamping operation. The reciprocating die 202 faces toward the surface of the continuous polishing layer 304. Multiple teeth 205 on the die 202 penetrate the surface of the continuous polishing layer 304. The stamping operation provides a surface finishing operation. For example, the teeth 205 indents a pattern of grooves in the surface of the polishing layer 304. The conveyor 110 may be intermittently paused, and becomes stationary when the dies 202 and 204 close toward each other. Alternatively, the dies 202 and 204 move in synchronization with the conveyor 110 in the direction of transport during the time when the dies 202 and 204 close toward each other.

Manufacturing station 208 includes, for example, a rotary saw 210 for cutting grooves in the surface of the continuous polishing layer 304. The saw 210 is moved by, for example, a orthogonal motion plotter along a predetermined path to cut the grooves in a desired pattern of grooves. Another manufacturing station 212 includes a rotating milling head 214 for buffing or milling the surface of the continuous polishing layer 304 to a flat, planar surface with a desired surface finish that is selectively roughened or smoothed.

The sequence of the manufacturing stations 202, 210 and 212 can vary from the sequence as disclosed by FIG. 2. One or more of the manufacturing stations 202, 210 and 212 can be eliminated as desired. The take up reel 130 and second drive mechanism 104 comprise, a separate manufacturing station that is selectively positioned in the manufacturing apparatus 200 at the end of the conveyor 110 to gather the solid phase continuous polishing pad 300.

Referring now to FIG. 3, a sectional view of the multi-layered, poromeric polishing pad 300 manufactured by the apparatus 100 of the present invention is provided. As discussed above, upon curing in the oven 128, the liquid phase polymer forms a solidified, poromeric polishing pad 300. In one embodiment, the polishing pad 300 may comprise columns 306. The columns 306 provides porosity that may be interconnected through the thickness of the polishing layer 304. In this way, the polishing debris may be absorbed into the polishing layer 304 and distributed away from the polishing layer (interface) toward the lower surface of the top, polishing layer 304. Also, the top layer, which will be compressible due to its high porosity and saturation in polishing fluid, can act as a pump forcing the fluid against the wafer surface during repetitive cyclic transitions under the wafer. Additionally, the interconnected pore structure of the polishing pad 300 may be uniform throughout the thickness of the polishing layer 304 such that, as the pad wears, the pore cross-sectional geometry and surface area in contact with the wafer remains constant.

Preferably, the polishing layer 304 will essentially be “rubbery” under polishing conditions with a Shore D hardness of the bulk polymer of less than 40D. More preferably, the polishing layer will have a Shore D hardness of the bulk polymer of less than 30D. Most preferably, the polishing layer will have a Shore D hardness of the bulk polymer of less than 25D. Also, the polishing layer 304 has a thickness of less than 0.5 mm. More preferably, the polishing layer has a thickness of less than 0.4 mm. Most preferably, the polishing layer has a thickness of less than 0.25 mm.

As discussed above, substrate 302 comprises a “dual” sub-pad design, including an intermediate, stiff layer 312 and a compressible layer 314. In this way, the stiff, intermediate layer 312 balances stiffniess at die-scale lengths but works in conjunction with the more compressible layer 314 to be flexible at wafer-scale lengths. This enables the pad to conform to non-planar wafers. Suitable materials for the middle layer are polymer films such as polyethylene terephthalate and polycarbonate or blends thereof. Preferred thickness for the intermediate layer 312 is less than 0.38 mm, preferably between 0.13 mm to 0.26 mm.

The bottom, compressible layer 314 will be more compressible than the intermediate layer 312 but less compressible than the top, polishing layer 304. Suitable materials for the bottom layer 314 include, for example, non-porous elastomeric sheets and high density closed cell polymer foams. Also, in order to prevent liquid intrusion into the foam, the polymer should be hydrophobic. Preferred polymers include, for example, silicone elastomers that have excellent hydrolytic stability, chemical and thermal resistance and rebound characteristics. The bottom layer 314 should be sufficiently compressible to improve polishing uniformity across the wafer diameter but not too compressible such that ability to planarize and edge effects become problematic. Preferred thicknesses for the lower layer are less than 1 mm, preferably less than 0.64 mm and most preferably less than 0.25 mm. Compressibility values should be less than 10 percent, preferably less than 5 percent, and most preferably around 3 percent. Compressibility may be tested in accordance with the ASTM F36-99 procedure (“Standard Test Method for Compressibility and Recovery of Gasket Materials”). Rebound values should be greater than 90 percent, preferably greater than 95 percent and most preferred greater than 98 percent.

Referring now to FIG. 3A, in another embodiment of the polishing pad 300 of the present invention, an entrained constituent in the form of, a foaming agent or blowing agent or a gas, is included in the polymer mixture, which serves as a matrix that is entrained with the constituent. Upon curing, the foaming agent or blowing agent or gas escapes as volatiles to provide the open pores 308 distributed throughout the continuous polishing layer 304. Polishing pad 300 of FIG. 3A further comprises the substrate 302. Again, as above, the pores 308 provide porosity that may be interconnected through the thickness of the polishing layer 304. In this way, in conjunction with the substrate 302, the polishing debris may be absorbed into the polishing layer 304 and distributed away from the polishing layer (interface) toward the lower surface of the top, polishing layer 304. Also, the top layer, which will be compressible due to its high porosity and saturation in polishing fluid, can act as a pump forcing the fluid against the wafer surface during repetitive cyclic transitions under the wafer. Additionally, the interconnected pore structure of the polishing pad 300 may be uniform throughout the thickness of the polishing layer 304 such that, as the pad wears, the pore cross-sectional geometry and surface area in contact with the wafer remains constant.

Referring now to FIG. 3B, another embodiment of the polishing pad 300 is disclosed, comprising microballons or polymeric microelements 310 included in the polymer mixture, and distributed throughout the continuous polishing layer 304. The microelements 310 may be gas filled. Alternatively the microelements 310 are filled with a polishing fluid that is dispensed when the microelements 310 are opened by abrasion when the polishing pad 300 is used during a polishing operation. Alternatively, the microelements 310 are water soluble polymeric microelements that are dissolved in water during a polishing operation. Polishing pad 300 of FIG. 3B further comprises the substrate 302. In this way, in conjunction with the substrate 302, the polishing debris may be absorbed into the polishing layer 304 and distributed away from the polishing layer (interface) toward the lower surface of the top, polishing layer 304. Also, the top layer, which will be compressible due to its high porosity and saturation in polishing fluid, can act as a pump forcing the fluid against the wafer surface during repetitive cyclic transitions under the wafer. Additionally, the interconnected pore structure of the polishing pad 300 may be uniform throughout the thickness of the polishing layer 304 such that, as the pad wears, the pore cross-sectional geometry and surface area in contact with the wafer remains constant.

Preferably, at least a portion of the microelements 310 are generally flexible. Suitable microelements 310 include inorganic salts, sugars and water-soluble particles. Examples of such polymeric microelements 310 include polyvinyl alcohols, pectin, polyvinyl pyrrolidone, hydroxyethylcellulose, methylcellulose, hydropropylmethylcellulose, carboxymethylcellulose, hydroxypropylcellulose, polyacrylic acids, polyacrylamides, polyethylene glycols, polyhydroxyetheracrylites, starches, maleic acid copolymers, polyethylene oxide, polyurethanes, cyclodextrin and combinations thereof. The microelements 310 may be chemically modified to change the solubility, swelling and other properties by branching, blocking, and crosslinking, for example. A preferred material for the microsphere is a copolymer of polyacrylonitrile and polyvinylidene chloride (e.g., Expancel™ from Akzo Nobel of Sundsvall, Sweden).

Preferably, as discussed above, the multi-layered, poromeric polishing pads 300 may contain a porosity or filler concentration of at least 50 volume percent. This porosity or filler contributes to the polishing pad's ability to transfer polishing fluids during polishing. In other words, the increased levels of porosity allows the interconnectivity of the polishing pad. More preferably, the polishing pad has a porosity or filler concentration of at least 65 volume percent. Most preferably, the polishing pad has a porosity or filler concentration of at least 75 volume percent. Preferably the pores or filler particles have a weight average diameter of 10 to 100 μm. Most preferably, the pores or filler particles have a weight average diameter of 15 to 90 μm. The nominal range of expanded hollow-polymeric microelements' weight average diameters is 15 to 50 μm.

Accordingly, the present invention provides a multi-layered polishing pad with reduced defectivity and improved polishing performance. The polishing pad of the present invention is a multi-layered, poromeric polishing pad having a polishing layer that has a porosity level of at least 50 volume percent or greater. Preferably, the polishing pad is manufactured in a web-format and reduces the pad-to-pad variations often associated with cast and skived “hard” polishing pads. In addition, the polishing pad is preferably water-based rather than organic-solvent based, and has a greater yield and less defects than prior art “soft” pads formed by a solvent based coagulation process. Hence, the present multi-layered polishing pad provides step-out defectivity performance, generating flat topography at wafer, die and feature size scale lengths.

What is claimed is:

1. A composite chemical mechanical polishing pad for polishing a semiconductor substrate comprising,
a polishing layer having a first compressibility;
an intermediate layer having a second compressibility less than the first compressibility;
a bottom layer having a third compressibility greater than the second compressibility and less than the first compressibility; and
wherein the polishing layer has at least a fifty volume percent level of porosity.

2. The polishing pad of claim 1 wherein the polishing layer has a Shore D hardness of less than 40D.

3. The polishing pad of claim 1 wherein the polishing layer has a thickness of less than 0.5 mm.

4. The polishing pad of claim 1 wherein the polishing layer comprises a polymeric matrix formed of a water-based polymer or blends thereof.

5. The polishing pad of claim 4 wherein polymeric matrix is a urethane dispersion, acrylic dispersion, styrene dispersion or blends thereof.

6. The polishing pad of claim 4 wherein the polymeric matrix comprises a blend of by weight percent 100:1 to 1:100 urethane to acrylic dispersion.

7. The polishing pad of claim 4 wherein the polymeric matrix further comprises a defoamer, rheology modifier, anti-skinning agent or coalescent agent.

8. The polishing pad of claim 4 wherein the polymeric matrix has microelements dispersed therein, the microelements being selected from the group comprising polyvinyl alcohols, pectin, polyvinyl pyrrolidone, hydroxyethylcellulose, methylcellulose, hydropropylmethylcellulose, carboxymethylcellulose, hydroxypropylcellulose, polyacrylic acids, polyacrylamides, polyethylene glycols, polyhydroxyetheracrylites, starches, maleic acid copolymers, polyethylene oxide, polyurethanes, cyclodextrin, polyvinylidene dichloride, polyacrylonitrile and combinations thereof.

9. The polishing pad of claim 1 wherein the intermediate layer has a thickness of less than 0.4 mm.

10. The polishing pad of claim 1 wherein the bottom layer has a thickness of less than 1 mm.
